(19) United States
(12) Patent Application Publication
(10) Pub. No.: US 2007/0063631 A1
(43) Pub. Date: Mar. 22, 2007

(54) Cathode ray electron gun with an improved beam formation structure

(76) Inventors: Gregoire Gissot, Plombiere les dijon (FR); Pierre Bizot, Marsannay La Cote (FR)

Correspondence Address: THOMSON LICENSING INC., PATENT OPERATIONS, PO BOX 5312, PRINCETON, NJ, 08543-5312, US

(21) Appl. No.: 11/444,717

(22) Filed: Jun. 1, 2006

(30) Foreign Application Priority Data
Jun. 3, 2005 (FR) 0551505

(51) Int. Cl. H01J 29/50; H01J 29/46

(52) U.S. Cl. 313/409; 313/414; 313/441

(57) ABSTRACT

The invention relates to an electron gun for cathode ray tubes comprising a cathode emitting an electron beam according to a determined propagation axis, and, aligned in series according to this axis, successively a first electrode, a second electrode. The first electrode comprises a first plate featuring rectangular apertures, the edges of which have a constant thickness. The second electrode comprises a second plate featuring circular apertures of diameter Φ greater than the largest dimensions of the rectangular apertures. They will preferably be: 0.7 mm≦W≦0.9 mm 0.5 mm≦H≦0.7 mm 0.5 mm≦Φ≦0.9 mm and the distance d between the first and second electrodes such that: 3.34 mm≦d≦0.45 mm Applications: Electron gun for cathode ray tube.

The invention relates to an electron gun for cathode ray tubes and particularly an electron gun in which the astigmatism is precorrected in the low section of the gun, namely, in the electron beam formation region between the cathode and the main lens. The invention also relates to a cathode ray tube applying such an electron gun.

### BACKGROUND OF THE INVENTION

In an electron gun for cathode tube, a main lens (G8-G9 in FIG. 1) is used to focus the electronic beam on the centre of the screen together with a prefocusing lens (G3-G4G5) that adjusts the size of the beam and finally a BFR (beam formation region) G1-G2 that composes the emissive source.

In the study of a static gun the resolution on the screen strongly depends on the shape of the electronic beam formed by the gun.

The current trend is to manufacture tubes that deflect electronic beams capable of being greater than 110 degrees so as to reduce the depth of the tubes. These large deflections create large distortions (particularly astigmatism) of the electron beams at the edge of the screen and notably in the corners of the screen. To compensate for these distortions, one solution consists in controlling the size of the beams at the level of the gun in accordance with the pre-deflection.

This involves producing an astigmatic beam that has a greater level of resolution at the edge of the picture. Usually, the astigmatism that is registered in an electron gun is the property of the main lens owing to the sufficiently elliptical forms of the apertures for creating a dissymmetric beam between its horizontal direction and vertical direction. The said astigmatism value is fixed according to optical improvement criteria, it is also related to the deviation effect on the system.

The situation of a static gun requires a strong dissymmetry of the beam to overcome the consequences of the pre-deflection of the electronic beam at each position of the screen, which gives a highly elongated beam in the horizontal plane and a very thin beam in the vertical plane. The negative outcome of this situation is too great a discrepancy of formation of the planes between the vertical lines and the horizontal lines in the centre of the screen This astigmatism is too high and difficult to reduce without breaking the mechanical structure of the main lens very advantageous for reducing the spherical aberrations.

The three main parts of an electron gun as shown in FIG. 1a, are the BFR electronic beam zone, the prefocusing zone PREFOC and the main lens.

BFR is the zone of the emission and creation of the beam delimited by the cathode and the input into a lens known as a prefocusing lens. This concerns two grids (G1, G2) in the present description.

The distribution of the astigmatism depends on the three parts of the gun (BFR+PREFOCUSING+MAIN LENS) or sometimes two parts (BFR+MAIN LENS).

In these two situations, one astigmatism value is always set at the main lens according to optical improvement criteria (such as aberrations or the adjustment of a gun operating point). From this, the astigmatism must be adapted from the other two or three parts.

The invention relates both to the contribution of the astigmatism of the main lens to the reduction of the aberration coefficient of this same lens and to the implementation of an astigmatic system realised in the low section of the electron gun, the BFR.

The invention relates to an electron gun for cathode ray tube incorporating a two electrode system for the formation of the electron beam with a structure of suitable electrodes, having (FIG. 1b) a fixed voltage (Vf) that enables the screen resolution to be obtained.

The purpose of the invention is to optimise the astigmatism of the gun (discrepancy between the formation of the horizontal line and vertical line planes) to improve the size and shape of the spots on the screen.

One undesirable effect of too high an astigmatism in an electron gun involves too great an imbalance of the spot on the screen between the vertical size and the horizontal size. Concretely the astigmatism is the discrepancy between the horizontal size X and the vertical size Y (FIG. 2) of an element whose horizontal and vertical dimensions should be equal if there was no astigmatism:

Astigmatism=Size X−Size Y

The astigmatism is also expressed in focusing voltage, which minimises the horizontal dimension (focusH) and the voltage that minimises the vertical dimension (focusV)

Astigmatism=focusH−focusV

In a static gun, the astigmatism is corrected by the main lens, focal point of the horizontal and vertical dissymmetry. It has been observed that the reduction in the horizontal spherical aberration coefficient follows the gun astigmatism in linear manner (se FIG. 3). The invention resolves this disadvantage.

The realisation of an astigmatic phenomenon in the low section of the gun can be linked to the conformation of a circular grid onto which is added a rectangular “slot” type aperture whose efficiency is slightly attenuated with regard to a strongly rectangular and unique aperture as this is described for example in the U.S. Pat. No. 5,760,550. However, manufacturing this astigmatic grid is complex as it is multiform thus difficult to control from a mechanical point of view.

### SUMMARY OF THE INVENTION

The invention thus relates to an electron gun for cathode ray tube comprising a cathode emitting an electronic beam according to a determined propagation axis. It also comprises, aligned in series according to this axis, successively a first electrode, a second electrode and at least one output lens of the electron gun. The first electrode comprises a first plate featuring at least one rectangular aperture for which the axis of symmetry is the said axis. The edges of this rectangular aperture have a constant thickness around the entire aperture. Moreover, the second electrode comprises a second plate featuring at least one circular aperture on the said propagation axis. The large dimension of the rectangular aperture of the first electrode is less than the diameter of the circular aperture of the second electrode.

It is advantageously provided that the large dimension of the said rectangular aperture is parallel to the horizontal plane of the gun.

Moreover, according to the invention provision can be made to adapt the astigmatism induced by the different main parts of the electron gun, namely the astigmatism of the electron beam formation zone, the astigmatism of the prefocusing lens and the astigmatism of the main lens such that these three units give:

$$Σ ASTIG\_TOTAL ( gun ) = ASTIG ( BFR ) + ASTIG ( PREFOC ) + ASTIG ( Main Lens ) + interaction ( BFR + PFOC ) + interaction ( PFOC + Main Lens )$$

More specifically, it is provided that the astigmatism of the electron gun is obtained by the following polynomial, irrespective of the value of the astigmatism that is selected:

$$Σ ASTIG\_TOTAL ( gun ) = ao + {a}_{1} \times ( AST\_BFR ) + {a}_{2} \times ( AST\_PFOC ) + {a}_{3} \times ( AST\_Lens ) + {a}_{12} \times ( AST\_BFR ) \times ( AST\_PFOC ) + {a}_{23} \times ( AST\_BFR ) \times ( AST\_PFOC )$$

In this polynomial:
(AST BFR) is the astigmatism induced by the formation zone of the electron beam where:
   1000 V≦(ASTIG_BFR)≦1000 V,
(AST PFOC) is the astigmatism of a prefocusing lens (PREFOC) situated between the electron beam formation zone(BFR) and the main lens where:
   0 V≦(ASTIG_PFOC)≦−1000 V
(AST Lens) is the astigmatism induced by the main lens where:
   0 V≦(ASTIG_Lens)≦2500 V,

a0, a1, a2, a3, a12, a23 are constant coefficients that noticeably have the values indicated in the following table.

| Coefficients | Values |
|---|---|
| a0 | −885341E−04 |
| a1 | 10459.1E−04 |
| a2 | 8503.7E−04 |
| a3 | 11764.8E−04 |
| a12 | 1.3125E−04 |
| a23 | 1.1107E−04 |

The large dimension of the rectangular aperture of the first electrode is preferably less than the diameter of the circular aperture of the second electrode.

To obtain an astigmatism of a specific value ASTIG(BFR) that the said first and second electrodes must induce, the dimensions of the apertures of the two electrodes and the distance separating these two electrodes are determined by the relationship:
ASTIG(BFR)=b0+b1.W+b2.H+b3.d+b12.W.H+b13.W.d+b11.W²+b22.H²+b33.d²

In which:
W is the length of a long side of the aperture of the first electrode (G1),
H is the length of a short side of the aperture of the first electrode (G1),
Φ is the diameter of the aperture of the second electrode (G2). It is equal to or greater than the largest dimension of G1 (H, W),
d is the distance between the two electrodes (G1 and G2),
b0, b1, b2, b3, b12, b13, b11, b22, b33, are the constants.

According to one preferred embodiment of the invention, the dimensions of the electrodes will be provided such that:
the length W of the large size of the aperture of the first electrode is between 0.7 mm and 0.9 mm or is equal to one of these values,
the length H of the small side of the aperture of the first electrode is between 0.5 mm and 0.7 mm or is equal to one of these values,
the diameter Φ of the aperture of the second electrode is between 0.5 mm and 0.9 mm or is equal to one of these values it follows the largest dimension (W or H),
the distance d between both electrodes is between 0.34 mm and 0.45 mm or equal to one of these values.

The invention can also be applied to a cathode ray tube comprising an electron gun emitting electronic beams together with a deflection system enabling these beams to be deflected according to a maximum angle greater than 110 degrees. This gun incorporates an electron gun thus described.

### BRIEF DESCRIPTION OF THE DRAWINGS

The different objects and characteristics of the invention will appear more clearly in the description that follows as well as in the annexed figures, wherein:

FIG. 1a and 1b, an electron gun as known in the art,

FIGS. 2 and 3, respectively an explanatory figure of the astigmatism and a curve of the variation in the astigmatism according to the reduction of the spherical aberrations,

FIG. 4, curves showing the astigmatism of an electron gun in two different situations,

FIGS. 5a to 5c, an embodiment according to the invention,

FIGS. 6a and 6b, diagrams showing the astigmatism responses of a gun example according to the invention.

### DETAILED DESCRIPTION OF THE PREFERRED EMBODIMENTS

According to the invention, it is provided to create the astigmatism in opposition with the astigmatism of the main lens of an electron gun, which enables the aberrations to be limited by keeping the structure of the upper part of the gun (main lens side), and thus to be able to restrict the overall astigmatism of the gun which is greater than 2000 Volts. Hence this involves precorrecting the astigmatism generated by the main lens, in the low section of the gun.

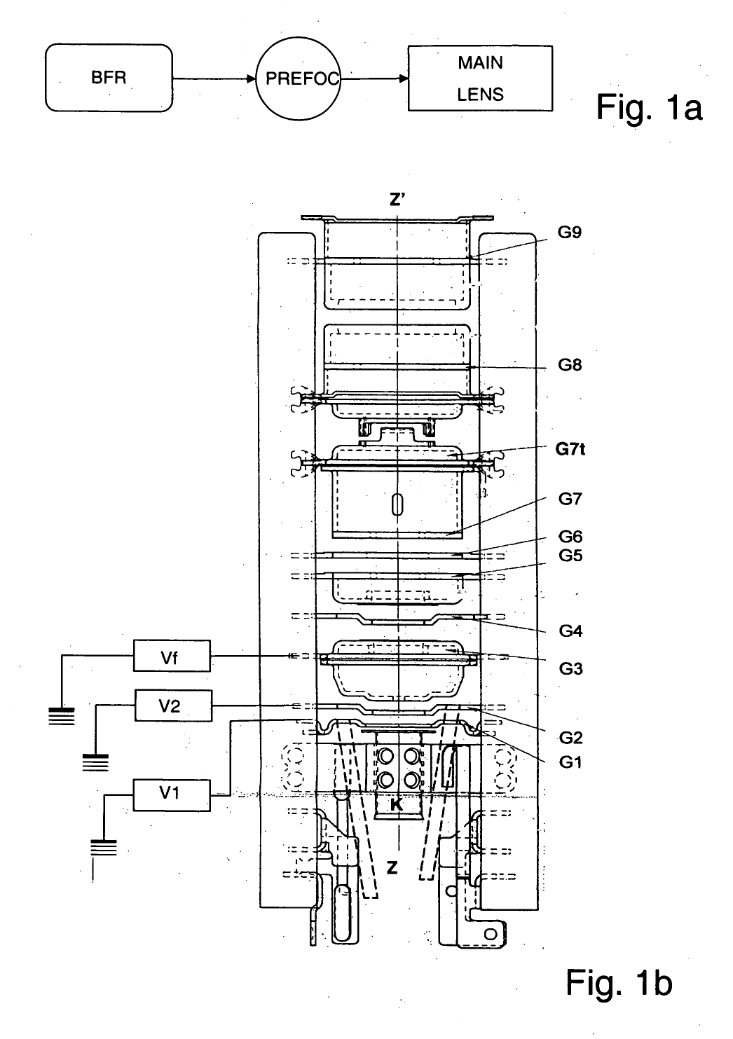

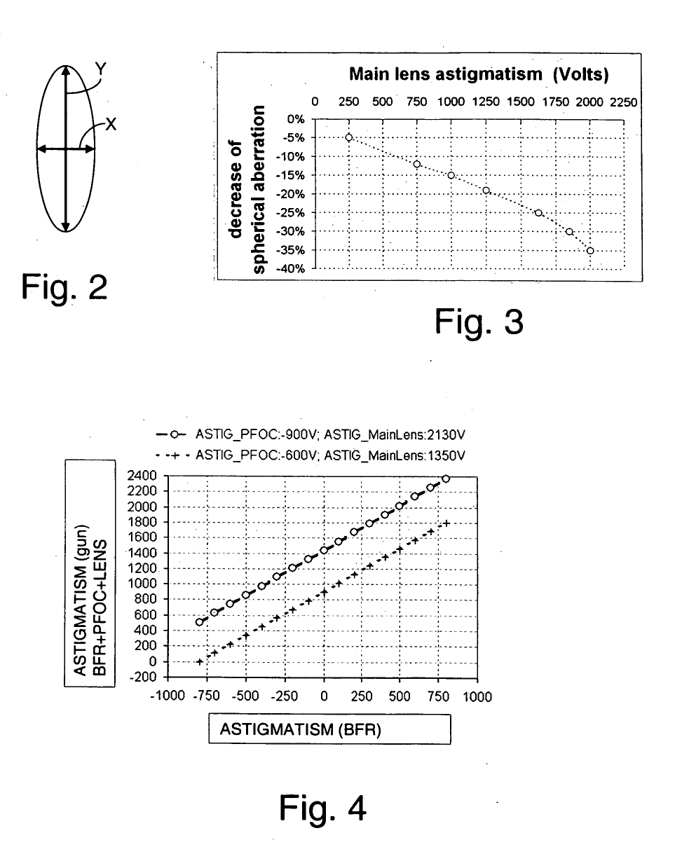

In an electron gun as schematised by FIG. 1a, the distribution of the astigmatism depends on the three parts of the gun (BFR+PREFOC+MAIN LENS) or sometimes two parts (BFR+MAIN LENS).

In these two situations, an astigmatism value is always set for the main lens according to optical improvement criteria (such as the aberrations of the adjustment of a gun operating point). From this, the astigmatism of the other parts must be adapted. The invention relates both to the low section of the gun (the BFR), as well as the possible behaviour of the prefocusing lens, which also contributes to the astigmatism value.

The three units BFR, PREFOC and MAIN LENS induce a total astigmatism:

$$Σ ASTIG\_TOTAL ( gun ) = ASTIG ( BFR ) + ASTIG ( PREFOC ) + ASTIG ( Main Lens ) + interaction ( BFR + PFOC ) + interaction ( PFOC + Main Lens )$$

According to the invention, the total and functional astigmatism of an electron gun is designed to be the sum of the three astigmatisms (BFR+PFOC+ML) plus fairly low but not negligible interactions translated by the following polynomial, irrespective of the astigmatism value that is chosen:

$$Σ ASTIG\_TOTAL ( gun ) = ao + {a}_{1} \times ( AST\_BFR ) + {a}_{2} \times ( AST\_PFOC ) + {a}_{3} \times ( AST\_Lens ) + {a}_{12} \times ( AST\_BFR ) \times ( AST\_PFOC ) + {a}_{23} \times ( AST\_BFR ) \times ( AST\_PFOC )$$

| Coefficients | Values |
|---|---|
| a0 | −885341E−04 |
| a1 | 10459.1E−04 |
| a2 | 8503.7E−04 |
| a3 | 11764.8E−04 |
| a12 | 1.3125E−04 |
| a23 | 1.1107E−04 |

In this polynomial, it is advantageously provided that the astigmatism values comply with the following conditions:
−1000 V≦ASTIG_BFR≦1000 V
0 V≦(ASTIG_PFOC)≦−1000 V
0 V≦(ASTIG_LENS)≦2500 V

Within the framework of the invention, it is sought to optimise the astigmatism of the BFR by taking into account the astigmatism values of other lenses. Two separate situations are proposed as examples.

In one case, the astigmatism of the prefocusing lens is set to −900V and the main lens to +2130V.

In the other case, for a prefocusing lens at −600V and a main lens at 1350V, the equation is still linear but shifted.

As illustrated by the curves in FIG. 4, it is noted that for two situations of clearly distant astigmatisms in the lens, for example 1350 V and 2130 V, the conditions for obtaining a total astigmatism in the gun of a value of 800 Volts for example requires the presence of −550 V of astigmatism in the BFR for the astigmatism pair PREFOC/Main lens (−900 V, 2130 V) and −90 V for the astigmatism pair PREFOC/ML (−600 V, 1350 V).

The invention relates both to the contribution of the astigmatism of the main lens to the reduction of the aberration coefficient of this same lens and in the implementation of an astigmatic system realised in the low section of the electron gun (in the BFR).

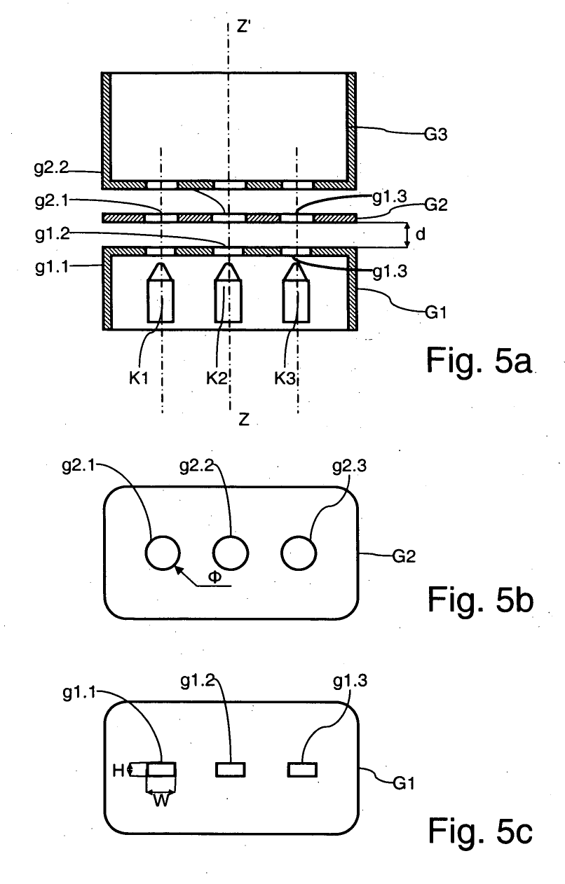

FIGS. 5a to 5c thus show an embodiment of electrodes according to the invention. In these figures, only the cathodes and the electrodes G1, G2 and G3 have been shown. These electrodes correspond to the electrodes G1 to G3 of the gun of FIG. 1.

The electrode G1 is a metal plate comprising rectangular apertures g1.1, g1.2 and g1.3 situated facing the axes of cathodes K1, K2 and K3. These apertures have a width W and height H.

The electrode G2 is a metal plate comprising circular apertures g2.1, g2.2, g2.3 of diameter Φ, situated in line with the apertures of the electrode G1 and cathodes K1, K2 and K3. The diameter of the apertures of the electrode G2 is at least greater than the largest dimension W of the apertures of the electrode G1.

The electrode G1 is at zero potential and the potential V2 will be applied to the electrode G2.

Both electrodes are at a distance d from each other.

The apertures of electrode G1 are oriented such that its greatest dimension is perpendicular to the horizontal direction of the gun corresponding to the horizontal axis of the screen of the tube in which the gun is mounted.

The dimensions W, H and Φ of the apertures of electrodes G1 and G2 and the distance d of both electrodes are determined with a view to obtaining a determined astigmatism in the BFR. The variation of the astigmatism ASTIG_BFR is expressed in mathematical form by a second degree polynomial expression (empirical) applicable within the entire parameter variability domain (W. H, Φ, d). The dimensions W, H, d and Φ are therefore determined by using the following polynomial model:

$$ASTIG ( BFR ) = bo + b 1 \cdot W + b 2 \cdot H + b 3 \cdot d + b 12 \cdot W \cdot H + b 13 \cdot W \cdot d + b 11 \cdot {W}^{2} + b 22 \cdot {H}^{2} + b 33 \cdot {d}^{2}$$

In this polynomial, b0, b1, b2, b3, b12, b13, b11, b22, b33, are constants that have been determined and that noticeably have the values indicated in the following table:

| COEFFICIENTS | VALUES |
|---|---|
| b33 | 3614 |
| b22 | −3786 |
| b11 | 3894 |
| b13 | −6057 |
| b12 | 1990 |
| b3 | 1391 |
| b2 | 8060 |
| b1 | −7923 |
| b0 | −362 |

According to one preferred embodiment, the dimensions of the apertures of the electrodes will thus be provided such that:

0.7 mm≦W≦0.9 mm

0.5 mm≦H≦0.7 mm

0.5 mm≦Φ≦0.9 mm

and the distance d between the electrodes G1 and G2 will be provided such that:

3.35 mm≦d≦0.45 mm

In an electron gun equipped with such electrodes G1 and G2, the total astigmatism ASTIG of the gun can vary between 0 Volts and +2000 Volts.

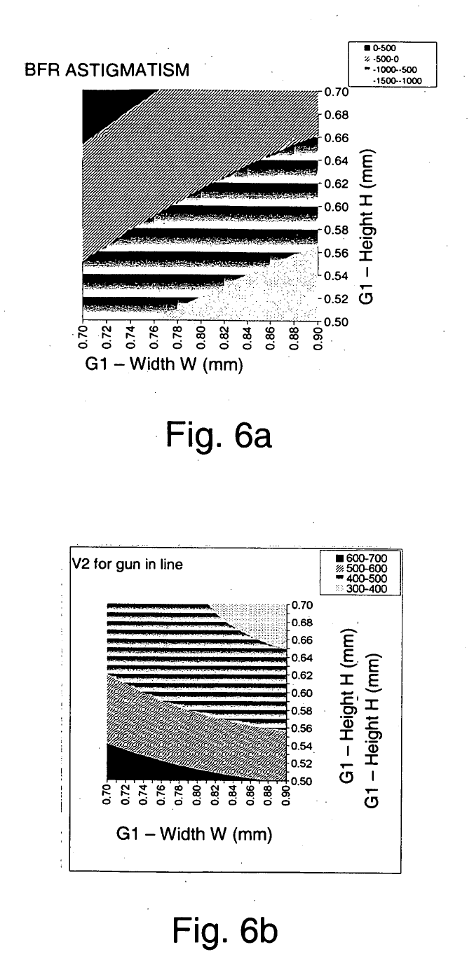

The correlation coefficient is very satisfactory and assumes a very good relationship between the variables of the model and the astigmatism, an example of which can be seen in the representation in the form of a graph in FIG. 6a. This graph shows the astigmatism responses of an electron gun with a grid G2, the apertures of which have the diameter Φ=0.79 mm and with the grids separated by d=0.381 mm. On the x and y axes, one finds respectively the values W and H of the apertures of the grid G1.

Likewise, the variation in astigmatism in the low section of the gun leads to a dispersion of the voltage V2 applied at the electrode G2 (voltage that enables electrons to be extracted from the emissive zone of the cathode). The “cut-off” voltage also changes according to a polynomial mathematical model, such that:

$$V 2 = c 0 + c 1 \cdot W + c 2 \cdot H + c 3 \cdot Φ + c 4 \cdot d + c 23 \cdot H \cdot Φ + c 24 \cdot H \cdot d + c 11 \cdot {W}^{2} + c 22 \cdot {H}^{2}$$

| COEFFICIENTS | VALUES |
|---|---|
| c22 | 4147 |
| c11 | 962 |
| c24 | −2287 |
| c23 | −592 |
| c4 | 2322 |
| c3 | 403 |
| c2 | −4742 |
| c1 | −1924 |
| c0 | 2350 |

Finally, the aforementioned relations are valid for 8000 Volts≦Vf≦9000 Volts; a required solution (ASTIG, V2) is obtained with:
−1000 Volts≦ASTIG(BFR)≦1000 Volts
and
350 Volts≦V2≦650 Volts

The gun obtained thus reduces the tension V2, which is an advantage for the television set chassis in which it is advantageous to reduce the operating voltages as far as possible (the value of the voltage V2 being generally around 900 volts).

The use of a purely rectangular grid adjoined to another circular grid, whose purpose is a more accurate control of the total astigmatism of the gun is a means of allowing the astigmatism of the main lens of the gun to drift, which greatly reduces the spherical aberrations while controlling the intrinsic value of the astigmatism required.

The unique rectangular grid in the low section thus enables the astigmatism to be controlled perfectly for the least cost as it is easier to produce in large quantities (simple to manufacture).

However, dimensional constraints must be respected (ratio H/V of the rectangular grid, represents the ‘Horizontal-dimension’/‘vertical-dimension’ of the aperture). The simulations and results obtained have taken into account these constraints to overcome the problem of current density. Some dimensions not described can be obstacles to the different cathode emission laws. In the context of a preferred embodiment of a gun according to the invention, the shape factor is limited to: H/V<1.8. It should be noted that it is however preferable not to exaggerate this ratio. The electronic emission zone is critical and very rapidly becomes problematic for recognition by the electro-optical modelling. The limit can advantageously be set to H/V-1.54 which provides the experiment current curves according to the voltage fairly close to the result expected.

What is claimed is:

1. Electron gun for cathode ray tube comprising at least one cathode emitting a electron beam according to a determined propagation axis, and, aligned in series according to this axis, successively a first electrode, a second electrode, and at least one output lens of the electron gun, the said first electrode comprising a first plate featuring at least one rectangular aperture, wherein:
the edges of the said rectangular aperture of the said first plate have a constant thickness all around the aperture,
and in that the second electrode comprises a plate featuring at least one circular aperture centred on the said axis, the large dimension of the rectangular aperture of the first electrode being less than the diameter of the circular aperture of the second electrode.

2. Electron gun according to claim 1, wherein the large dimension of the said rectangular aperture is parallel to the horizontal plane of the gun.

3. Electron gun according to claim 2, wherein the total astigmatism of the gun is obtained by the formula:
ΣASTIG_TOTAL=ao+a₁×(AST_BFR)+a₂×(AST_PFOC)+a₃×(AST_Lens)+a₁₂×(AST_BFR)×(AST_PFOC)+a₂₃×(AST_BFR)×(AST_PFOC).
In which:
(AST BFR) is the astigmatism induced by the formation zone of the electron beam where:
−1000 V≦(ASTIG_BFR)≦1000 V,
(AST PFOC) is the astigmatism of a prefocusing lens (PREFOC) situated between the electron beam formation zone(BFR) and the main lens where:
0V≦(ASTIG_PFOC)≦−1000 V
(AST Lens) is the astigmatism induced by the main lens where:
0 V≦(ASTIG_Lens)≦2500 V,
a₀, a₁, a₂, a₃, a₁₂, a₂₃ are constant coefficients.

4. Electron gun according to claim 3, wherein the coefficients a₀, a₁, a₂, a₃, a₁₂, a₂₃ noticeably have the following values:
a0=−885341E-04
a1=10459.1E-04
a2=8503.7E-04
a3=11764.8E-04
a12=1.3125E-04
a23=1.1107E-04

5. Electron gun according to claim 4, wherein for an astigmatism of a determined value ASTIG that the said first and second electrodes must induce, the dimensions of the apertures of the two electrodes as well as the distance separating these two electrodes are determined by the relationship:
ASTIG(BFR)=b0+b1.W+b2.H+b3.d+b12.W.H+b13.W.d+b11.W²+b22.H²+b33.d2
In which:
W is the length of a long side of the aperture of the first electrode,
H is the length of a short side of the aperture of the first electrode,
Φ is the diameter of the aperture of the second electrode it follows the largest dimension of the pair,
d is the distance between the two electrodes,
b0, b1, b2, b3, b12, b13, b11, b22, b33, are the constants.

6. Electron gun according to claim 5, wherein:
the length W of the large side of the aperture of the first electrode is between 0.7 mm and 0.9 mm or is equal to one of these values,
the length H of the short side of the aperture of the first electrode is between 0.5 mm and 0.7 mm or is equal to one of these values,
the diameter Φ of the aperture of the second electrode is between 0.5 mm and 0.9 mm or is equal to one of these values. It follows the largest dimension of the pair,
the distance d between both electrodes is between 0.34 mm and 0.45 mm or equal to one of these values.

7. Cathode ray tube comprising an electron gun emitting electron beams together with a deflection system enabling the said electron beams to be deflected according to a maximum angle greater than 110 degrees, incorporating an electron gun according to claim 1.
